(19) United States
(12) Patent Application Publication
(10) Pub. No.: US 2026/0316589 A1
(43) Pub. Date: Oct. 15, 2026

(54) CONTROL OF A DUAL INVERTER MOTOR SYSTEM

(71) Applicant: GM GLOBAL TECHNOLOGY OPERATIONS LLC, DETROIT, MI (US)

(72) Inventors: Yilun Luo, Ann Arbor, MI (US); Minh-Khai Nguyen, Troy, MI (US); Lei Hao, Shelby Township, MI (US); Brian A. Welchko, Oakland Township, MI (US)

(21) Appl. No.: 19/174,280

(22) Filed: Apr. 9, 2025

(51) Int. Cl. B60L 15/20; B60L 53/16; B60L 55/00; H02P 27/08

(52) U.S. Cl. CPC B60L 15/20; B60L 53/16; B60L 55/00; H02P 27/08; B60L 2210/40; B60L 2240/12; B60L 2240/423; B60L 2240/526

(57) ABSTRACT

A system includes a monitoring device configured to monitor a parameter of a multi-phase electric motor of a dual inverter motor system, and a controller connected to the dual inverter motor system. The dual inverter motor system includes a first inverter and a second inverter connected to the multi-phase electric motor, the first inverter including a first plurality of phase legs and the second inverter including a second plurality of phase legs. The controller is configured to control a set of switches of the second inverter to convert the dual inverter motor system between an open winding mode and a closed winding mode.

### INTRODUCTION

The disclosure relates to vehicles having electric motors. More specifically, the disclosure relates to control of electric motor propulsion systems.

Electric and hybrid vehicles are powered, at least in part, by electric motors. A typical propulsion system of such a vehicle includes an electric motor driven by a battery system via a conversion system that includes an inverter. Open winding motor systems are increasingly used, as such systems provide benefits that include higher voltage inputs that allow for increases in high speed operating ranges. It is desirable to provide systems and methods that improve efficiency and performance of open winding motor systems.

### SUMMARY

In one exemplary embodiment, a system includes a monitoring device configured to monitor a parameter of a multi-phase electric motor of a dual inverter motor system, and a controller connected to the dual inverter motor system. The dual inverter motor system includes a first inverter and a second inverter connected to the multi-phase electric motor, the first inverter including a first plurality of phase legs and the second inverter including a second plurality of phase legs. The controller is configured to control a set of switches of the second inverter to convert the dual inverter motor system between an open winding mode and a closed winding mode.

In addition to the one or more features described herein, the multi-phase electric motor is driven by controlling switches in both the first plurality of phase legs and the second plurality of phase legs when the dual inverter motor system is in the open winding mode.

In addition to the one or more features described herein, the controller is configured to convert the dual inverter motor system to the closed winding mode by operating the set of switches of the second inverter to electrically connect the second plurality of phase legs to a connection point of a set of windings of the multi-phase electric motor.

In addition to the one or more features described herein, one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

In addition to the one or more features described herein, each additional pulse of the additional pulses is provided based on a sum of voltages produced by the phase signal pulses.

In addition to the one or more features described herein, each additional pulse is provided during a drive cycle based on a time at which the sum of the voltages is greater than or less than zero.

In addition to the one or more features described herein, the first plurality of phase legs includes a first set of upper switches and a first set of lower switches, and the second plurality of phase legs includes a second set of upper switches and a second set of lower switches.

In addition to the one or more features described herein, the controller is configured to convert the dual inverter motor system to the closed winding mode by simultaneously closing each of the second set of upper switches or each of the second set of lower switches.

In addition to the one or more features described herein, the dual inverter motor system is part of a propulsion system of a vehicle, and the controller is configured to convert the dual inverter motor system between the open winding mode and the closed winding mode based on the monitored parameter, the monitored parameter being at least one of a vehicle speed and an amount of torque generated by the multi-phase electric motor.

In another exemplary embodiment, a method includes monitoring a parameter of a multi-phase electric motor of a dual inverter motor system, the dual inverter motor system including a first inverter and a second inverter connected to the multi-phase electric motor, the first inverter including a first plurality of phase legs and the second inverter including a second plurality of phase legs. The method also includes, based on the monitored parameter, controlling a set of switches of the second inverter to convert the dual inverter motor system between an open winding mode and a closed winding mode.

In addition to the one or more features described herein, the motor is driven by controlling switches in both the first plurality of phase legs and the second plurality of phase legs when the dual inverter motor system is in the open winding mode.

In addition to the one or more features described herein, the dual inverter motor system is converted to the closed winding mode by operating the set of switches of the second inverter to electrically connect the second plurality of phase legs to a connection point of a set of windings of the multi-phase electric motor.

In addition to the one or more features described herein, one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

In addition to the one or more features described herein, each additional pulse of the additional pulses is provided based on a sum of voltages produced by the phase signal pulses.

In addition to the one or more features described herein, each additional pulse is provided during a drive cycle based on a time at which the sum of the voltages is greater than or less than zero.

In addition to the one or more features described herein, the first plurality of phase legs includes a first set of upper switches and a first set of lower switches, the second plurality of phase legs includes a second set of upper switches and a second set of lower switches, and the dual inverter motor system is converted to the closed winding mode by simultaneously closing each of the second set of upper switches or each of the second set of lower switches.

In yet another exemplary embodiment, a vehicle system includes a dual inverter motor system including a first inverter and a second inverter connected to a multi-phase electric motor. The first inverter includes a first plurality of phase legs and the second inverter includes a second plurality of phase legs, the first plurality of phase legs includes a first set of switches, and the second plurality of phase legs includes a second set of switches. The vehicle system also includes a monitoring device configured to monitor a parameter of the multi-phase electric motor of the dual inverter motor system, and a controller connected to a dual inverter motor system, the controller configured to control the second set of switches of the second inverter to convert the dual inverter motor system between an open winding mode and a closed winding mode.

In addition to the one or more features described herein, the controller is configured to convert the dual inverter motor system to the closed winding mode by operating the set of switches of the second inverter to electrically connect the second plurality of phase legs to a connection point of a set of windings of the multi-phase electric motor.

In addition to the one or more features described herein, one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

In addition to the one or more features described herein, the controller is configured to convert the dual inverter motor system between the open winding mode and the closed winding mode based on the monitored parameter, the monitored parameter being at least one of a vehicle speed and an amount of torque generated by the multi-phase electric motor.

The above features and advantages, and other features and advantages of the disclosure are readily apparent from the following detailed description when taken in connection with the accompanying drawings.

### BRIEF DESCRIPTION OF THE DRAWINGS

Other features, advantages, and details appear, by way of example only, in the following detailed description, the detailed description referring to the drawings in which:

FIG. 1 is a schematic diagram of an electric or hybrid vehicle, in accordance with an exemplary embodiment;

FIG. 2 is a circuit diagram illustrating a dual inverter motor system, in accordance with an exemplary embodiment;

FIGS. 3A and 3B depict the dual inverter motor system of FIG. 2 in a closed winding mode, in accordance with an exemplary embodiment;

FIG. 4 represents the functionality of each inverter of the dual inverter motor system of FIGS. 2 and 3 when the dual inverter motor system is in a closed winding mode, in accordance with an exemplary embodiment;

FIG. 5 is a set of graphs representing phase signal pulses generated during a drive cycle of a dual inverter motor system, in accordance with an exemplary embodiment; and

FIG. 6 depicts a computer system for performing aspects of charging and discharging, in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

In accordance with exemplary embodiments, methods, devices and systems are provided for control of a dual inverter motor system. The dual inverter motor system may be part of an electric or hybrid vehicle.

The dual inverter motor system includes a three-phase (or other multi-phase) electric motor connected to a first inverter and a second inverter. Each inverter includes a plurality of phase legs connected in parallel to a bus, where each phase leg includes at least two switches. Each winding of the motor is connected to a phase leg of the first inverter and a phase leg of the second inverter. The various switches of the dual inverter motor system are operable by a controller to drive the motor according to an open winding mode and a closed winding mode.

The controller operates the motor system in the open winding mode by controlling all of the phase legs of the first inverter and the second inverter. The controller is configured to convert the motor to a closed winding mode by controlling switches in the first inverter or the second inverter.

For example, the controller operates the motor system according to the closed winding mode by controlling the phase legs of the first inverter according to a pulse width modulation scheme. During a drive cycle, the controller simultaneously operates all of the upper switches (or all of the lower switches) of the second inverter to generate additional pulses, thereby acting as an additional phase leg. In this mode, the second inverter is controlled to apply the additional pulses to the motor windings to reduce or eliminate a common mode voltage.

Embodiments described herein present a number of advantages. The embodiments provide for improved motor efficiency, for example, by providing functionality to dynamically switch from an open winding mode to a closed winding mode based on vehicle load and/or other parameter(s). This functionality allows for conversion to open winding mode at high speed operation to fully utilize available power, and for conversion to closed winding operation at lower speeds (partial loads). In addition, the embodiments are achievable without the need to add any components (e.g., switches or busbars).

In addition, embodiments improve efficiency by enabling closed winding mode operation to reduce or eliminate common mode voltage and thereby reduce or eliminate bearing currents and electromagnetic interference (EMI).

Three-phase inverters in electric vehicles generate common mode voltage (CMV). Switching in inverters causes voltage transients, which lead to CMV, bearing currents (currents through bearings in a motor) that can result in damage, and common mode EMI that can increase motor loss. Reducing the slew rate to address such transients increases inverter losses and limits peak current capability. The embodiments address these limitations by providing control methods that reduce or eliminate the voltage transients without the need to reduce slew rates or add more complexity.

The embodiments are not limited to use with any specific vehicle or device or system that utilizes battery assemblies, and may be applicable to various contexts. For example, embodiments may be used with automobiles, trucks, aircraft, construction equipment, farm equipment, automated factory equipment and/or any other device or system that may use high voltage battery packs or other battery assemblies.

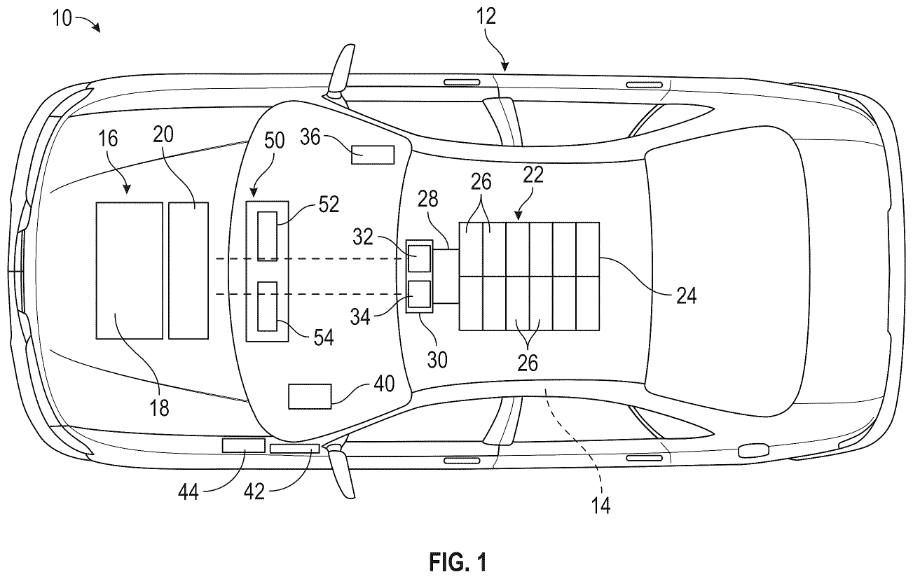

FIG. 1 shows an embodiment of a motor vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, a fuel injection subsystem, an exhaust subsystem and others.

The vehicle 10 may be a combustion engine vehicle, an electrically powered vehicle (EV) or a hybrid vehicle. In an embodiment, the vehicle 10 is a hybrid vehicle that includes a combustion engine system 18 and at least one electric motor assembly. In an embodiment, the propulsion system 16 includes an electric motor 20, and may include one or more additional motors positioned at various locations. The vehicle 10 may be a fully electric vehicle having one or more electric motors.

The vehicle 10 includes a battery system 22, which may be electrically connected to the motor 20 and/or other components, such as vehicle electronics. The battery system 22 may be configured as a rechargeable energy storage system (RESS). In an embodiment, the battery system 22 includes a battery assembly such as a high voltage battery pack 24 having a plurality of battery modules 26.

The battery system 22 is electrically connected to components of the propulsion system 16. The propulsion system includes a direct current (DC)-DC converter 28, and an inverter system 30 (e.g., a traction power inverter unit or TPIM) configured to convert DC power from the battery system 22 to poly-phase alternating current AC power (e.g., three-phase, six-phase, etc.) to drive the motor 20.

In an embodiment, the electric motor 20 is an open winding motor, which is driven by a dual inverter system. The inverter system 30, in this embodiment, is a dual inverter system that includes two inverters 32 and 34. The inverters may be two-level or multilevel (i.e., three-level or higher). Each winding of the motor 20 is connected to a phase leg of both inverters, as discussed further herein. Although two inverters are discussed, embodiments are not so limited, as an additional inverter or inverters may be included if the motor 20 has additional windings.

Various control modules (electronic control modules or ECUs) may be included in the vehicle 10. For example, a vehicle controller 36 is configured to control operation of the motor 20 and the inverter system 30. The vehicle controller 36 drives the motor by applying a pulse width modulation (PWM) scheme to control switches in the dual inverter system. The controller 36 may control the motor 20 according to an open winding mode and a closed winding mode as described herein.

Other examples of control modules include a power module 40 that is configured to control aspects of charging the battery pack 24, and discharging the battery pack to supply power to an external system, such as a power grid or other vehicle. The power module 40 is selectively connected to a charging outlet 42 and/or an electrical outlet 44. It is noted that embodiments are not limited to the number or location of outlets shown, as there may be any number of outlets at desired locations throughout the vehicle.

The vehicle 10 also includes a computer system 50 that includes one or more processing devices 52 and a user interface 54. The various processing devices and units may communicate with one another via a communication device or system, such as a controller area network (CAN) or transmission control protocol (TCP) bus.

Although embodiments are described using the vehicle controller 36 to perform functions described herein, embodiments are not so limited. Any suitable processor or processing system may be used for various control functions.

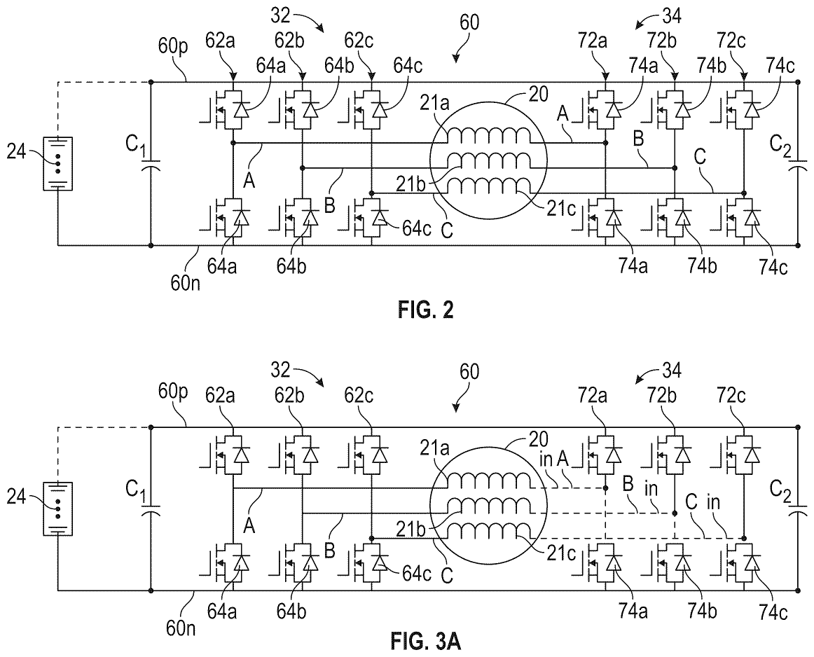

FIG. 2 depicts an embodiment of a dual inverter system. The dual inverter system is described as part of the vehicle 10. However, the dual inverter system may be part of any suitable vehicle or other system.

The motor 20 is connected to the inverters 32 and 34. The inverters 32 and 34 are connected in parallel with each other to a propulsion bus 60. The propulsion bus 60 includes a positive bus 60p and a negative bus 60n.

Each inverter 32 and 34 includes a switching assembly having at least two inverter switches connected to each phase of the motor 20. In this example, the motor 20 is a three-phase motor coupled to phases A, B and C of the inverters 32 and 34. The motor 20 includes a first winding 21a (phase A winding), a second winding 21b (phase B winding) and a third phase winding 21c (phase C winding)

For example, the inverter 32 includes a first phase leg 62a having a pair of switches 64a, a second phase leg 62b having a pair of switches 64b, and a third phase leg 62c having a pair of switches 64c. Likewise, the inverter 34 includes a first phase leg 72a having a pair of switches 74a, a second phase leg 72b having a pair of switches 74b, and a third phase leg 72c having a pair of switches 74c.

In an embodiment, each inverter switch is a semiconductor switch. As non-limiting examples, inverter switches may include metal-oxide-semiconductor (MOS)-controlled Thyristors (MCTs), gallium-nitride (GaN) field-effect transistors (FETs), metal-oxide-semiconductor field-effect transistors (MOSFETs), silicon carbide junction field-effect transistors (SiC JFETs), insulated-gate bipolar transistors (IGBTs) or any other suitable low loss device of suitable voltage and current ratings. The inverters 32 and 34 can each have a capacitor, C1 and C2, or share one single capacitor.

Each phase leg includes an upper switch and a lower switch. An “upper” switch is a switch located between a connection to a winding and the positive bus 60p, and a “lower” switch is a switch located between the connection and the negative bus 60n.

The first phase leg 62a of the inverter 32 and the first phase leg 72a of the inverter 34 are each connected to an end of the first winding 21a (phase A winding). The second phase leg 62b and the second phase leg 72b are each connected to an end of the second winding 21b (phase B winding), and the third phase leg 62c and the third phase leg 72c are each connected to an end of the third winding 21c (phase C winding).

The motor 20 may be operated in an “open winding” mode, in which each phase of the motor 20 is driven according to a modulation scheme (e.g., pulse width modulation or PWM) by a full bridge inverter stage (i.e., two pairs of switches). The motor 20 may also be operated in a “closed winding” mode, in which phases A, B and C are driven by one of the inverters.

In an embodiment, the closed winding mode provides for three-phase control by one of the inverters, and creation of an additional fourth phase leg by controlling switches in the other inverter. In the following description, the inverter 32 is controlled to generate A, B and C phase signals according to PWM modulation, and the inverter 34 is controlled to function as the additional phase leg. However, it is to be understood that the roles of the inverters may be reversed.

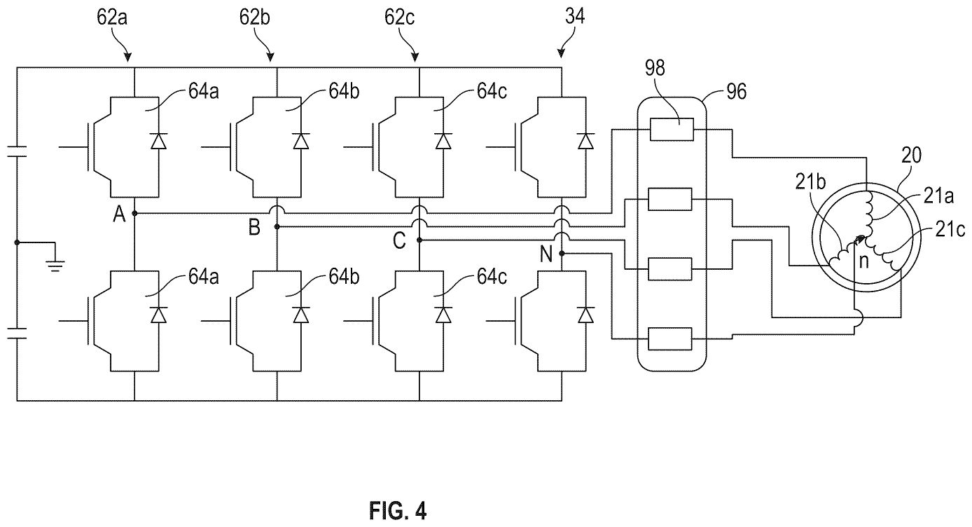

In the closed winding mode, controlling the switches in the inverter 34 is performed so that that the inverter 34 generates an additional phase signal (a fourth phase signal if the inverters are three-phase inverters). The additional phase signal includes a series of pulses that are coordinated with the other three phase signals to eliminate common mode voltage. “Common mode voltage” (CMV) occurs when the sum of the voltages of the windings is non-zero (i.e., greater than or less than zero, greater than a positive voltage threshold, and/or less than a negative voltage threshold), resulting in a non-zero voltage at a connection point. The connection point is a point at which the motor windings connect together (an example of a connection point n is shown in FIG. 4).

The controller 36 can operate the switches according to the open winding mode to maximize the available voltage under conditions such as high load conditions. A high load condition may be a high speed or high torque (e.g., when the vehicle 10 is in a high performance mode).

The controller 36 can switch to the closed winding mode, in which the dual inverter system acts as a single three phase inverter (e.g., Y-winding inverter) that applies three phases to the motor 20, along with a fourth phase (also referred to as phase N) that is applied in coordination with the other phases to eliminate CMV.

In an embodiment, in the closed winding mode, the controller 36 generates phase N pulses by closing and opening all of the lower switches or upper switches of the simultaneously. The PWM scheme applies the phase N pulses so as to eliminate CMV.

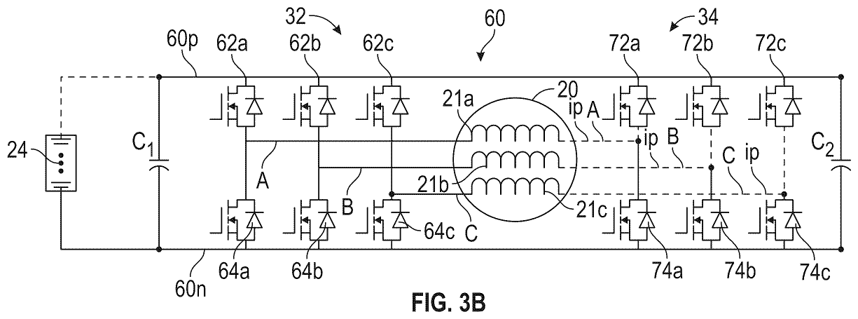

FIGS. 3A and 3B are representations of the dual inverter system during operation in the closed winding mode. Although the inverter 34 is described as providing phase N pulses, embodiments are not so limited. For example, the inverter 34 can instead provide phase A, B and C pulses, while the inverter 32 provides phase N pulses.

To provide phase N pulses, the inverter 34 alternates between a first switching position and a second switching position. In the first switching position, shown in FIG. 3A, the lower switches of the phase legs 72a, 72b and 72c of the inverter 34 are closed or on, and the upper switches are open or off, thereby applying equal negative voltage to each of the phase A, B and C windings (corresponding to negative current iₙ). In the second switching position, shown in FIG. 3B, the lower switches of the phase legs 72a, 72b and 72c of the inverter 34 are off, and the upper switches are on, thereby applying equal positive voltage to each of the phase A, B and C windings (represented by positive current iₚ).

As shown in FIG. 4, when the lower or upper switches are alternately closed together, the inverter 34 functions as a fourth phase leg N that effectively applies a voltage to a connection point of the motor 20 to eliminate CMV.

In the example of FIG. 4, the motor 20 is configured as a Y-winding motor, and the connection point is shown schematically as the point where the three windings are connected to each other (point n). It is noted that the phase leg N is a virtual phase leg defining a virtual neutral point for point n. The phase leg N is functionally represented in FIG. 4, and is not intended to indicate a physical structure of the inverter 34 or the connection to the neutral point. An AC filter 96 may optionally be included, which includes a filter 98 (i.e., a resistor-inductor (RL) type filter, an inductor-capacitor (LC) type filter, etc.) for each phase leg. The AC filter 96 can be added between the (equivalent) 4-leg inverter and the motor 20 to facilitate the CMV cancellation.

In use, during vehicle operation, one or more parameters related to the motor 20 are monitored. A monitored parameter includes, for example, motor speed determined by a motor speed sensor and/or resolver, motor torque, requested torque (determined, for example, by monitoring driver inputs and/or commands from a vehicle control system), inverter/motor currents, temperatures, and/or vehicle speed.

A controller or processor determines whether operating conditions are most conducive to open winding or closed winding operation. For example, if the vehicle 10 is travelling at a relatively low speed or has a relatively low motor speed (e.g., less than 40% of maximum speed), the controller 34 controls the switches according to the closed winding mode. If the vehicle 10 is travelling at a relatively high speed or has a relatively higher motor speed, the controller 34 controls the switches according to the open winding mode.

During closed winding operation, the phase legs 62a, 62b and 62c are controlled according to a PWM scheme to apply phase signal pulses. Also during closed winding operation, the upper switches of the inverter 34 are simultaneously turned on and off, and the lower switches are simultaneously turned on and off as discussed above, to apply a series of pulses (phase N pulses) having a pulse width and duty cycle that is determined based on the voltages produced by the phase A, B and C signal pulses. The inverter 34 is operated to control the voltage at the virtual neutral point, at which the phase legs 62a, 62b and 62c virtually short the ends of the motor windings together.

In an embodiment, the duty cycle and/or pulse width may be dynamically adjusted during a drive cycle by continuously (i.e., at each sample time of a sensor) monitoring the voltages at each winding 21a, 21b and 21c, and varying the duty cycle to control the CMV at a zero or constant level. In an embodiment, the occurrence and timing of non-zero voltage sums (i.e., non-zero voltage at the connection point) may be simulated or determined in advance based on the parameters of a modulation scheme (e.g., PWM).

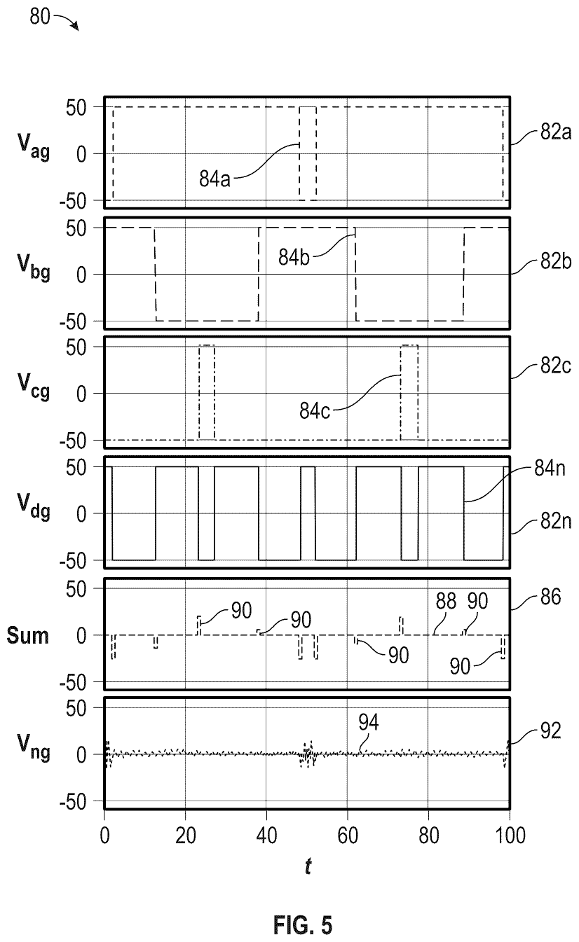

FIG. 5 depicts an example of PWM timing parameters that can be applied during closed winding operation. In this example, a timing diagram 80 represents PWM control parameters. The timing diagram shows the times of switching events (a switching event occurs when a switch is turned on or off) and corresponding phase pulses. Each of the graphs show voltage amplitude in Volts (V) as a function of time gm1 in nano-seconds (ns).

The timing diagram 80 includes a graph 82a that shows the timing of phase A pulses (curve 84a). Phase A pulses are represented by a voltage V_{ag} between the winding 21a and ground. A graph 82b shows phase B pulses (curve 84b) represented by a voltage V_{bg} between the winding 21b and ground, and a graph 82c shows phase C pulses (curve 84c) represented by a voltage V_{cg} between the winding 21c and ground.

A graph 84n shows the timing of phase N pulses (generated by simultaneously closing and opening the lower or upper switches of the inverter 34). The phase N pulses (voltage V_{dg}) are generated at times during a drive cycle that correspond to instances where the sum of the voltages (i.e., voltage at the connection point) is non-zero.

In this example, instances of zero voltages of common mode voltage are shown by a graph 86, which is the sum of the voltages of V_{ag}, V_{bg}, V_{cg} and V_{dg} (curve 88) at the virtual neutral point. Graph 92 shows V_{ng} values 94, where V_{ng} is the voltage between the virtual neutral point and ground. Ideally, the sum of the voltages V_{ag}, V_{bg}, V_{cg}, and V_{dg}, and the voltage at the neutral point n of the motor 20 (V_{ng}), should both be zero.

Spikes 90 show the instances where the sum is non-zero due to, for example, hardware limitations, such as propagation delays between phase pulses, or switching delay differences. As shown, the duty cycle and the pulse width of the phase N pulses is dynamically selected so that each phase N pulse has a beginning and an end that coincides with one of the A, B, or C phase pulses.

In this way, additional pulses are provided to maintain the common connection point as zero (i.e., keep the voltage at or near zero). This eliminates CMV and associated effects (e.g., bearing currents, and EMI).

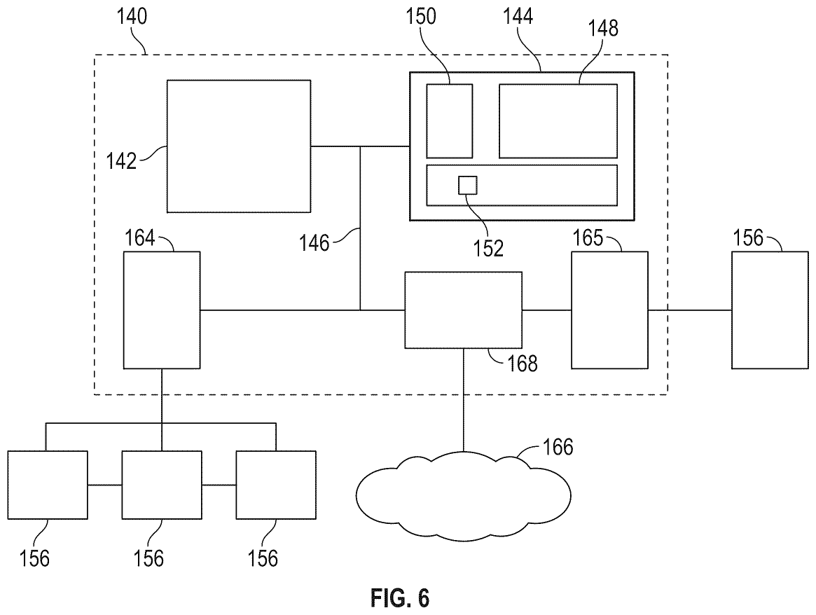

FIG. 6 illustrates aspects of an embodiment of a computer system 140 that can perform various aspects of embodiments described herein. The computer system 140 includes at least one processing device 142, which generally includes one or more processors for performing aspects of methods described herein.

Components of the computer system 140 include the processing device 142 (such as one or more processors or processing units), a memory 144, and a bus 146 that couples various system components including the system memory 144 to the processing device 142. The system memory 144 may include a variety of computer system readable media. Such media can be any available media that is accessible by the processing device 142, and includes both volatile and non-volatile media, and removable and non-removable media.

For example, the system memory 144 includes a non-volatile memory 148 such as a hard drive, and may also include a volatile memory 150, such as random access memory (RAM) and/or cache memory. The computer system 140 can further include other removable/non-removable, volatile/non-volatile computer system storage media.

The system memory 144 can include at least one program product having a set (e.g., at least one) of program modules that are configured to carry out functions of the embodiments described herein. For example, the system memory 144 stores various program modules that generally carry out the functions and/or methodologies of embodiments described herein. A module or modules 152 may be included to perform functions related to performing charging and discharging operations described herein. The system 140 is not so limited, as other modules may be included. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 142 can also communicate with one or more external devices 156 as a keyboard, a pointing device, and/or any devices (e.g., network card, modem, etc.) that enable the processing device 142 to communicate with one or more other computing devices. Communication with various devices can occur via Input/Output (I/O) interfaces 164 and 165.

The processing device 142 may also communicate with one or more networks 166 such as a local area network (LAN), a general wide area network (WAN), a bus network and/or a public network (e.g., the Internet) via a network adapter 168. It should be understood that although not shown, other hardware and/or software components may be used in conjunction with the computer system 40. Examples include, but are not limited to: microcode, device drivers, redundant processing units, external disk drive arrays, RAID systems, and data archival storage systems, etc.

The terms “a” and “an” do not denote a limitation of quantity, but rather denote the presence of at least one of the referenced items. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure is not limited to the particular embodiments disclosed, but will include all embodiments falling within the scope thereof.

What is claimed is:

1. A system, comprising:
a monitoring device configured to monitor a parameter of a multi-phase electric motor of a dual inverter motor system; and
a controller connected to the dual inverter motor system, the dual inverter motor system including a first inverter and a second inverter connected to the multi-phase electric motor, the first inverter including a first plurality of phase legs and the second inverter including a second plurality of phase legs, the controller configured to control a set of switches of the second inverter to convert the dual inverter motor system between an open winding mode and a closed winding mode.

2. The system of claim 1, wherein the motor is driven by controlling switches in both the first plurality of phase legs and the second plurality of phase legs when the dual inverter motor system is in the open winding mode.

3. The system of claim 1, wherein the controller is configured to convert the dual inverter motor system to the closed winding mode by operating the set of switches of the second inverter to electrically connect the second plurality of phase legs to a connection point of a set of windings of the multi-phase electric motor.

4. The system of claim 3, wherein one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

5. The system of claim 4, wherein each additional pulse of the additional pulses is provided based on a sum of voltages produced by the phase signal pulses.

6. The system of claim 5, wherein each additional pulse is provided during a drive cycle based on a time at which the sum of the voltages is greater than or less than zero.

7. The system of claim 1, wherein the first plurality of phase legs includes a first set of upper switches and a first set of lower switches, and the second plurality of phase legs includes a second set of upper switches and a second set of lower switches.

8. The system of claim 7, wherein the controller is configured to convert the dual inverter motor system to the closed winding mode by simultaneously closing each of the second set of upper switches or each of the second set of lower switches.

9. The system of claim 1, wherein the dual inverter motor system is part of a propulsion system of a vehicle, and the controller is configured to convert the dual inverter motor system between the open winding mode and the closed winding mode based on the monitored parameter, the monitored parameter being at least one of a vehicle speed and an amount of torque generated by the multi-phase electric motor.

10. A method comprising:
monitoring a parameter of a multi-phase electric motor of a dual inverter motor system, the dual inverter motor system including a first inverter and a second inverter connected to the multi-phase electric motor, the first inverter including a first plurality of phase legs and the second inverter including a second plurality of phase legs; and
based on the monitored parameter, controlling a set of switches of the second inverter to convert the dual inverter motor system between an open winding mode and a closed winding mode.

11. The method of claim 10, wherein the multi-phase electric motor is driven by controlling switches in both the first plurality of phase legs and the second plurality of phase legs when the dual inverter motor system is in the open winding mode.

12. The method of claim 10, wherein the dual inverter motor system is converted to the closed winding mode by operating the set of switches of the second inverter to electrically connect the second plurality of phase legs to a connection point of a set of windings of the multi-phase electric motor.

13. The method of claim 12, wherein one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

14. The method of claim 13, wherein each additional pulse of the additional pulses is provided based on a sum of voltages produced by the phase signal pulses.

15. The method of claim 14, wherein each additional pulse is provided during a drive cycle based on a time at which the sum of the voltages is greater than or less than zero.

16. The method of claim 10, wherein the first plurality of phase legs includes a first set of upper switches and a first set of lower switches, the second plurality of phase legs includes a second set of upper switches and a second set of lower switches, and the dual inverter motor system is converted to the closed winding mode by simultaneously closing each of the second set of upper switches or each of the second set of lower switches.

17. A vehicle system comprising:
a dual inverter motor system including a first inverter and a second inverter connected to a multi-phase electric motor, the first inverter including a first plurality of phase legs and the second inverter including a second plurality of phase legs, the first plurality of phase legs including a first set of switches, the second plurality of phase legs including a second set of switches;
a monitoring device configured to monitor a parameter of the multi-phase electric motor of the dual inverter motor system; and
a controller connected to a dual inverter motor system, the controller configured to control the second set of switches of the second inverter to convert the dual inverter motor system between an open winding mode and a closed winding mode.

18. The vehicle system of claim 17, wherein the controller is configured to convert the dual inverter motor system to the closed winding mode by operating the second set of switches of the second inverter to electrically connect the second plurality of phase legs to a connection point of a set of windings of the multi-phase electric motor.

19. The vehicle system of claim 17, wherein one of the first inverter and the second inverter is controlled to drive the multi-phase electric motor by operating the first plurality of phase legs or the second plurality of phase legs to apply phase signal pulses according to a pulse width modulation scheme to drive the multi-phase electric motor, and another of the first inverter and the second inverter is controlled to provide additional pulses in coordination with the phase signal pulses to reduce or eliminate a common mode voltage.

20. The vehicle system of claim 17, wherein the controller is configured to convert the dual inverter motor system between the open winding mode and the closed winding mode based on the monitored parameter, the monitored parameter being at least one of a vehicle speed and an amount of torque generated by the multi-phase electric motor.
